(19) United States
(12) Patent Application Publication
(10) Pub. No.: US 2008/0077855 A1
(43) Pub. Date: Mar. 27, 2008

(54) GENERIC WEBSITE

(76) Inventors: Shirel Lev, Haifa (IL); Hagai Toper, Los Angeles, CA (US)

Correspondence Address: EMPK & Shiloh, LLP, 116 JOHN ST,, SUITE 1201, NEW YORK, NY, 10038, US

(21) Appl. No.: 11/858,169

(22) Filed: Sep. 20, 2007

Related U.S. Application Data
(60) Provisional application No. 60/846,122, filed on Sep. 21, 2006.

(51) Int. Cl. G06F 3/023

(52) U.S. Cl. 715/236

(57) ABSTRACT

A system for interpreting data associated with a website, comprising an interface module adapted to receive data associated with a website, an interpreter adapted to interpret an unsupported portion of said data and a generator for generating standard data from the interpreted portion.

### RELATED APPLICATIONS

This application claims the benefit of U.S. Provisional Patent Application No. 60/846,122, filed Sep. 21, 2006, which is incorporated herein by reference.

### FIELD OF THE DISCLOSURE

Embodiments of the disclosure relate to interpretation, transcoding and translation of data associated with a web page.

### BACKGROUND

Web browsers, such as Microsoft Internet Explorer and Mozilla Firefox, are software products used for surfing the World Wide Web (or more commonly, the “Web”). Web browsers enable users to view and interact with internet web pages programmed in various technologies, such as HTML (HyperText Markup Language), Flash, Java, .Javascript and Ajax.

Traditionally, web browsers were being used on personal computers (PCs) running operating systems such as Microsoft Windows, Linux or MacOS. In recent years, advances in mobile phone and wireless technologies enabled Internet access on a wide variety of electronic mobile devices. Special mobile web browsers, or simply “mobile browsers” (sometimes also referred to as “nminibrowsers” or “microbrowsers”), were developed for use on these devices, which differ from personal computers in various ways. For instance, the display area on a typical mobile device is considerably smaller than that of a typical personal computer Since many websites are designed to fit a PC screen, they may not display correctly on a small screen of a mobile device, thereby degrading the user's ability to view these websites and interact with them. Moreover, due to the generally weaker computing power embodied in these mobile devices, they often lack the resources to handle complex web pages, such as those programmed using Flash, Java, Javascript and Ajax Therefore, most current mobile browsers are preemptively designed to display web pages in a relatively simple manner, ignoring some of the complex technologies that may be implemented within these pages.

Several other problems often arise when surfing the Web, problems that may affect mobile devices and PCs alike. For example, the source code of many websites, which usually comprises HTML-type markup language and/or CSS (Cascading Style Sheets) style language, does not fully conform to the web standards set by the W3C (The World Wide Web Consortium). Deviation from web standards sometimes causes web pages to appear differently on different web browsers, either PC web browsers or mobile browsers. In a more extreme scenario, a web browser may simply fail to interpret non-standard code of a web page; the web page's functionality may then be degraded, and the user may sometimes be presented with various error messages.

The W3C also regulates standards for web accessibility, which allow disabled persons to surf the Web and enjoy it in a way closest as possible to the way a non-disabled person would. Among these standards are the Web Content Accessibility Guidelines (WCAG), which regulate issues such as readability of web pages by vocal screen readers for the sight-impaired, and supply of alternative content for cases in which some features are inaccessible or unsupported. Websites that do not conform to the WCAG or other accessibility standards are often less accessible to disabled is persons, such as sight-impaired persons.

Another example of a problem that may affect web browsing is URLs (Uniform Resource Locators) having faulty syntax URLs which do not conform to a standardized form, are sometimes not recognized by web browsers, both PC web browsers and mobile browsers. A URL is a standardized reference to a networked resource, such as a web page, an image or a video found on the Web and the like. URLs are sometimes referred to as URLs (Uniform Resource Identifiers), A user may enter a website by typing its URL in the address bar of his web browser, or by clicking on a link incorporating the website's URL. An example of a URL is http//www.uspto.gov/main.newsandnotices.htm, which pertains to the United States Patent and Trademark Office “News and Notices” web page. The current standard syntax of URLs is defined in the Internet Society's RFC-3986 memorandum, the disclosure of which is located online at http//tools.ietf.org/html/rfc3986 and incorporated herein by reference, URLs which do not conform to RFC-3986 are sometimes not recognized by web browsers, thereby not allowing access to the websites referenced by these URLs. For example, URLs which include special characters or symbols not regulated in RF-C-3986, may not be interpreted correctly by web browsers, and users may fail to connect to the underlying websites. Furthermore, web browsers (very often mobile browsers) sometimes fail to interpret URLs, even though these URLs conform to RF C-3986. This usually happens when the URL comprises non-letter characters (such as spaces or symbols like c, & or #) which the web browser misunderstands, due to its inherent deficiencies.

### SUMMARY OF THE DISCLOSURE

An aspect of some embodiments of the disclosure relates to providing systems and methods of interpreting, transcoding and translating data associated with a web page.

In an embodiment of the disclosure, a web page is checked for associated HTML and/or CSS code which is incompatible with a W3C XHTML, (Extensible HyperText Markup Language) and/or CSS (Cascading Style Sheets) specifications, respectively. If incompatible code is found, it is interpreted and converted to valid XHTML or CSS code, respectively.

Optionally, the process of checking, interpreting and converting is initiated by a client web browser requesting the web page, and the converted valid XHTML and/or CSS code, respectively, is served to the requesting client web browser.

In an embodiment of the disclosure, a URL requested by a client web browser is checked for incompatibility with the client web browser and/or with a standard URL syntax. If the URL is determined to be incompatible with the client web browser and/or with the standard URL syntax, it is interpreted and converted to a compatible URL.

Optionally, the compatibility of the URL with the client web browser is determined by detecting the type of the client web browser using its User Agent string, and checking the URL interpretation capabilities of this type of web browser in a web browser capabilities database.

In an embodiment of the disclosure, a web technology associated with a web page requested by a client web browser is checked for incompatibility with the client web browser. If the web technology is determined to be incompatible with the client web browser, it is interpreted and converted to a different, compatible web technology, so that a same or a similar functionality of the web page is reserved.

Optionally, the compatibility of the web technology with the client web browser is determined by detecting the type of the client web browser using its User Agent string, and checking the web technology interpretation capabilities of this type of web browser in a web browser capabilities database.

Optionally, Javascript is interpreted and converted to XHTML, so that a same or a similar functionality of the web page is reserved.

In an embodiment of the disclosure, if a client web browser requesting a web page is a mobile browser, and a size of an image associated with the web page exceeds a predefined size, the image size is reduced to fit the predefined size.

Optionally, the predefined size corresponds to a viewable size of a mobile electronic device having the smallest viewable size amongst known mobile electronic devices.

In an embodiment of the disclosure, if a client web browser requesting a web page is a mobile browser, and a menu of the web page is not located at the bottom part of the web page, the web page is served to the client web browser with the menu appealing at the bottom part of the web page.

Optionally, the menu comprises at least two links associated with a same web site of the web page.

There is therefore provided, in accordance with an embodiment of the disclosure, a system for interpreting data associated with a web page, comprising an interface module adapted to receive data associated with a web page, an interpreter adapted to interpret an unsupported portion of said data, and a generator for generating standard data from the interpreted unsupported portion. Optionally, the data associated with a web page is HyperText Markup Language (HTML) code. Optionally, the data associated with a web page is Cascading Style Sheets (CSS) code. Optionally, the data associated with a web page is Javascript code. Optionally, the data associated with a web page is a Uniform Resource Locator (URL) string. Optionally, the system further comprises an image transcoder adapted to adjust an image size to fit a mobile device display. Optionally, the system further comprises a graphical user interface (GUI) translator, adapted to place one or more GUI elements associated with said web page at a bottom area of said web page.

There is further provided, in accordance with an embodiment of the disclosure, a method of interpreting data associated with a web page, comprising receiving data associated with a web page, interpreting an unsupported portion of said data, and generating standard data from the interpreted unsupported portion. Optionally, the data associated with a web page is HTML code. Optionally, the data associated with a web page is CSS code. Optionally, the data associated with a web page is Javascript code. Optionally, the data associated with a web page is a URL, string. Optionally, the method further comprises adjusting an image size to fit a mobile device display. Optionally, the method further comprises placing one or more GUI elements associated with said web page at a bottom area of said web page.

There is further provided, in accordance with an embodiment of the disclosure, a proxy server adapted to relay data associated with a web page, comprising an interface module adapted to relay data associated with a web page between a client and a web server, an interpreter adapted to interpret an unsupported portion of said data, and a generator for generating standard data from the interpreted unsupported portion. Optionally, the data associated with a web page is HTML code Optionally, the data to associated with a web page is CSS code Optionally, the data associated with a web page is Javascript code. Optionally, the data associated with a web page is a URL string. Optionally, the proxy server further comprises an image transcoder adapted to adjust an image size to fit a mobile device display. Optionally, the proxy server further comprises a GUI translator, adapted to place one or more GUI elements associated is with said web page at a bottom area of said web page.

### BRIEF DESCRIPTION OF THE FIGURES

Examples illustrative of embodiments of the disclosure are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIG. 1 schematically shows a data interpretation flow chart, in accordance with an embodiment of the disclosure;

FIG. 2 schematically shows a data interpretation flow chart, in accordance with an embodiment of the disclosure;

FIG. 3 schematically shows a data interpretation flow chart, in accordance with an embodiment of the disclosure;

FIG. 4 schematically shows a data interpretation flow chart, in accordance with an embodiment of the disclosure;

FIG. 5 schematically shows a data interpretation flow chart, in accordance with an embodiment of the disclosure;

FIG. 6A schematically shows a web page, in accordance with prior art;

FIG. 6B schematically shows a web page, in accordance with prior art;

FIG. 6C schematically shows a web page, in accordance with an embodiment of the disclosure; and

FIG. 7 schematically shows a network, in accordance with an embodiment of the disclosure;

### DETAILED DESCRIPTION OF EMBODIMENTS

An aspect of some embodiments of the disclosure relates to providing systems and methods of interpreting, transcoding and translating data associated with a web page.

In an embodiment of the disclosure, a web page is checked for associated HTML, code which is incompatible with a W3C XHTML specification. If incompatible code is found, it is interpreted and converted to valid XHTML code HTML is a markup language designed for the creation of web pages. HTML enables the display of text, links, images and/or other media types in a web browser HTML is written in the form of tags, surrounded by “less-than” (<) and “ggreater-thian” signs (>). Other then surrounding tags with “< >” signs, HTML syntax has many other rules. Until the year 2000, HTML syntax rules were not fully obeyed by web programmers, and loose syntax was very common among websites. For example, a <p> tag, which represents the beginning of a paragraph, was often not followed, at the end of the paragraph, by a </p> tag—as HTML rules required. In 2000, the W3C published the XHTML (Extensible HyperText Markup Language) 1.0 recommendation. XHTML is an HTML-type web programming language, which differs from regular HTML in factors such as strictness of syntax and separation of content and design (content is created in the HTML file, and this content's design is created by CSS syntax, either implemented within the HTML or as a separate file). Strictness of syntax is expressed, for example, in the requirement to have a closing tag (such as </a> after each tag (such as <a>). In 2006, a first draft of XHTML 2.0 was published, and is still in working process.

Unfortunately, many websites have not conformed their HTML syntax to the new XHTML 1.0 recommendation. Moreover, newer web browsers have begun to rely on XHTML 1.0 for interpreting websites, and are therefore encountering problems with interpreting loose, obsolete HTML code. To overcome the problem these loose HTML websites pose to some web browsers, an embodiment of the disclosure interprets HTML code which is incompatible with an XHTML specification (either XHTML 1.0, 2.0, or another version), and converts it to valid XHTML.

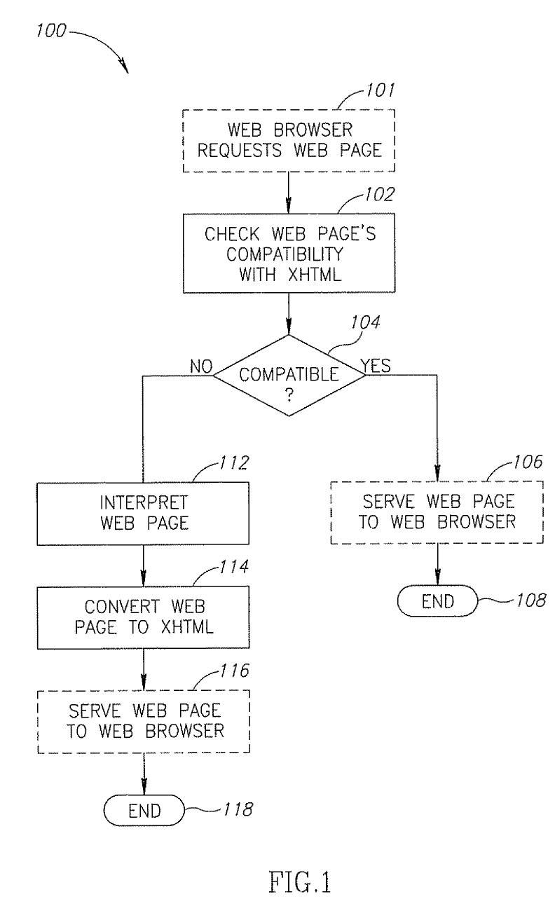

FIG. 1 is a flow chart schematically showing a process 100 of interpreting a web page, according to an embodiment of the disclosure. In a block 102, a web page is checked for compatibility with an XHTML, specification. The checking is performed by searching the web site's source code for a code segment which is not specified in the XHTML specification, or is not formulated according to this specification.

In a block 104, if incompatibility is not found, process 100 ends in a block 108. If incompatibility is found, the web page is interpreted in a block 112, Interpretation is optionally per formed using an interpreter, and may include an analysis of the incompatible code found, and determination of this code's meaning. For example, if the incompatible code is a <p> tag not having a closing </p> tag following it, it is understood that a closing </p> tag should have been present at the end of a paragraph following the <p> tag. In a block 114, the incompatible code is converted to valid XHTML, optionally using a generator. Continuing the previous example, a closing </p> tag is added after the paragraph associated with the <p> tag. Similarly, other incompatible code segments are converted, and valid XHTML, is generated. The actions of blocks 112 and 114 are optionally repeated, until all incompatible code segments are converted. In a block 118, process 100 is ended Optionally, the process of checking 102, interpreting 112 and converting 114 is initiated by a client web browser requesting the web page, and the converted valid XHTML code is served to the requesting client web browser. In this option, a block 101 is added prior to block 102. In block 101, a web browser requests a web page, thereby initiating process 100, for the ultimate purpose of serving an XHTML-compliant web page to the web browser. In a block 106, if the web page was found to be compatible with XHTML, it is served to the requesting browser. In a block 116, if a web page was found to be incompatible with XHTML and then interpreted 112 and converted to valid XHTML 114, it is served 106 to the web browser in its valid XHTML form.

In an embodiment of the disclosure, a web page is checked for associated CSS code which is incompatible with the W3C CSS specification. If incompatible code is found, it is interpreted and converted to valid CSS code.

CSS is a stylesheet language used to describe the presentation of a document written in a markup language. Its most common application is to style web pages written in HTML and/or XHTML. The current version of the CSS specification published by the W3C is 2.1. The first version (1.0) was published in the year 1996. Prior to the existence of CSS, nearly all of the presentational attributes of HTML, documents were contained within the HTML markup. Font colors, background styles, borders and sizes had to be explicitly described, often repeatedly, within the HTML, CSS allows authors to move much of that information to a separate stylesheet, resulting in considerably simpler HTML markup. Sometimes, CSS is implemented within the HTML markup itself and not as a separate stylesheet, but such practice becomes more and more rare.

Even though CSS existed for more than ten years, many websites still use CSS loosely, without fully obeying W3C CSS specifications. Some web browsers, therefore, encounter problems with interpreting loose CSS code, and may display web pages associated with the loose CSS code incorrectly. To overcome the problem such loose CSS websites pose to some web browsers, an embodiment of the disclosure interprets CSS code which is incompatible with a CSS specification (either 1.0, 2.1, or another version), and converts it to valid CSS.

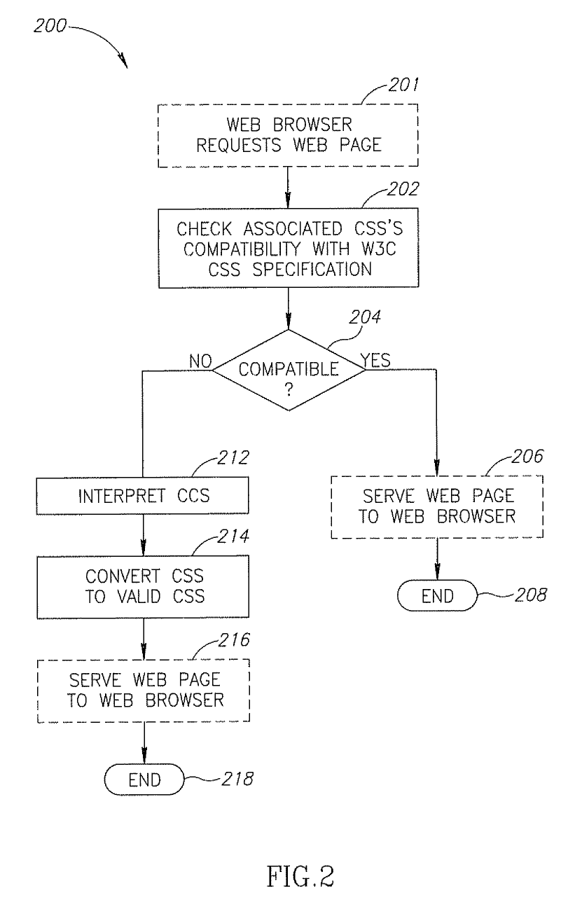

FIG. 2 is a flow chart schematically showing a process 200 of interpreting CSS associated with a web page, according to an embodiment of the disclosure. In a block 202, CSS associated with a web page is checked for compatibility with a CSS specification. The checking is performed by searching the web site's source code and/or CSS associated with it for a code segment which is not specified in the CSS specification, or is not formulated according to this specification.

In a block 204, if incompatibility is not found, process 200 ends in a block 208. If incompatibility is found, the CSS associated with the web page is interpreted in a block 212, optionally using an interpreter. Interpretation optionally includes an analysis of the incompatible code found, and determination of this code's meaning. In a block 214, the incompatible code is converted to valid CSS, optionally using a generator. The actions of blocks 212 and 214 are optionally repeated, until all incompatible code segments are converted. In a block 218, process 200 is ended.

Optionally, the process of checking 202, interpreting 212 and converting 214 is initiated by a client web browser requesting the web page, and the website, alongside its associated converted valid CSS code, is served to the requesting client web browser. In this option, a block 201 is added prior to block 202. In block 201, a web browser requests a web page, thereby initiating process 200, for the ultimate purpose of serving a web page having valid associated CSS, to the web browser. In a block 206, if the CSS was found to be compatible with a W3C CSS specification, it is served to the requesting browser alongside the website associated to it. In a block 216, if CSS associated with a web page was found to be incompatible with a W3C CSS specification and then was interpreted 212 and converted to valid CSS 214, it is served 206 to the web browser alongside its associated, converted CSS.

In an embodiment of the disclosure, a URL requested by a client web browser is checked for incompatibility with the client web browser and/or with a standard URL syntax. If the URL is determined to be incompatible with the client web browser and/or with the standard URL syntax, it is interpreted and converted to a compatible so URL.

Incompatibility of a URL with a web browser may stem from several reasons. For example, the URL's syntax may not be formulated according to RUC-3986 or a similar URL syntax standard. Also, some web browsers fail to interpret URLs correctly, even if these URLs do conform to the standardized form. This often happens when the URL comprises non-letter characters (such as spaces or symbols like <, & or #).

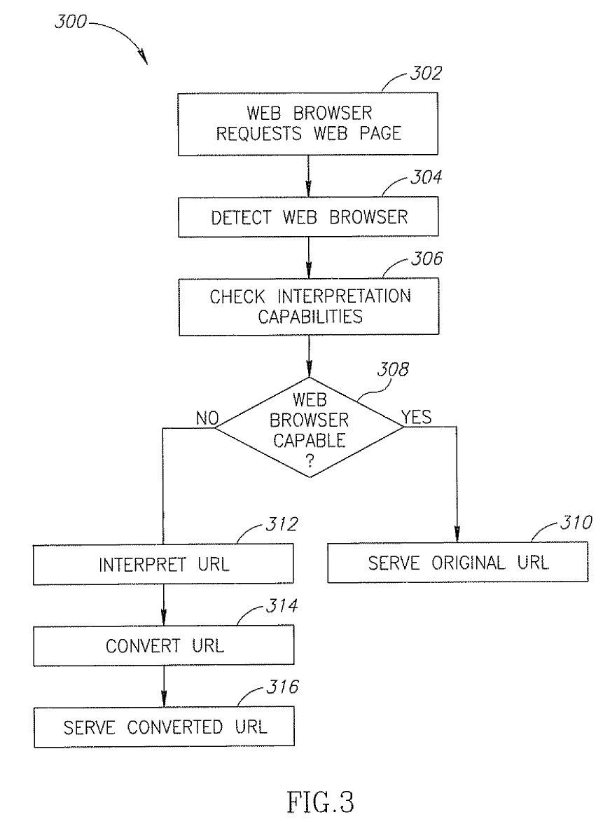

FIG. 3 is a flow chart schematically showing a process 300 of interpreting a URL associated with a web page, according to an embodiment of the disclosure. In a block 302, a web browser requests a web page, using its associated URL. In a block 304, the web browser's type is detected Optionally, the detection is performed using the web browser's User-Agent string. A User-Agent string is an identifier of a web browser, often transmitted by it to a web server during browsing. For example, a User-Agent string of a Flock v. 0.7 4.1 web browser, may be: “Mozilla/5.0 (Windows; U, Windows NT 5.1, en-US; rv 1 8 0.5) Gecko/20060731 Fiirefox/1 5.0.5 Flock/17 4.1”.

In a block 306, the URL interpretation capabilities of the detected web browser are checked. Optionally, the web browser identifier is looked up in a database of known web browsers and their URL interpretation capabilities. The database optionally includes information regarding web browsers that can handle standardized URLs properly, and others that may fail to do this in some cases. In a block 308, if the URL is determined to be compatible with the web browser, the website associated with the URL is served 310 to the web browser, without any changes made to the URL. If the URL is determined to be incompatible with the web browser, the URL is interpreted in a block 312, such as by an interpreter. The table below includes some examples of common characters that may exist within a URL and be incompatible with some web browsers:

| | Interpretation compatible with most |
|---|---|
| Possibly incompatible | web browsers (“percent” sign |
| characters | followed by a hexadecimal value) |
| Space | %20 |
| “Less than” symbol (<) | %3C |
| Comma (,) | %2C |
| Ampersand (&) | %26 |

In a block 314, after incompatible characters were interpreted, they are converted to characters compatible with the web browser, such as the values in the right column of the table above. Optionally, the conversion is being performed using a generator. In a block 316, the converted URL is served to the web browser, so that the web browser is able to access the web page associated with the URL.

In an embodiment of the disclosure, a web technology associated with a web page requested by a client web browser is checked for incompatibility with the client web browser. If the web technology is determined to be incompatible with the client web browser, it is interpreted and converted to a different, compatible web technology, so that a same or a similar functionality of the web page is reserved.

Some web browsers, either PC web browsers or mobile ones, are incapable of displaying web content created with certain web technologies, such as Javascript. This incapability is either inherent to the web browser, or stems from manual disabling of certain technologies in the web browser, performed by a user. Therefore, in an embodiment of the disclosure, a technology which is not supported by a web browser is interpreted and converted to a format the web browser supports.

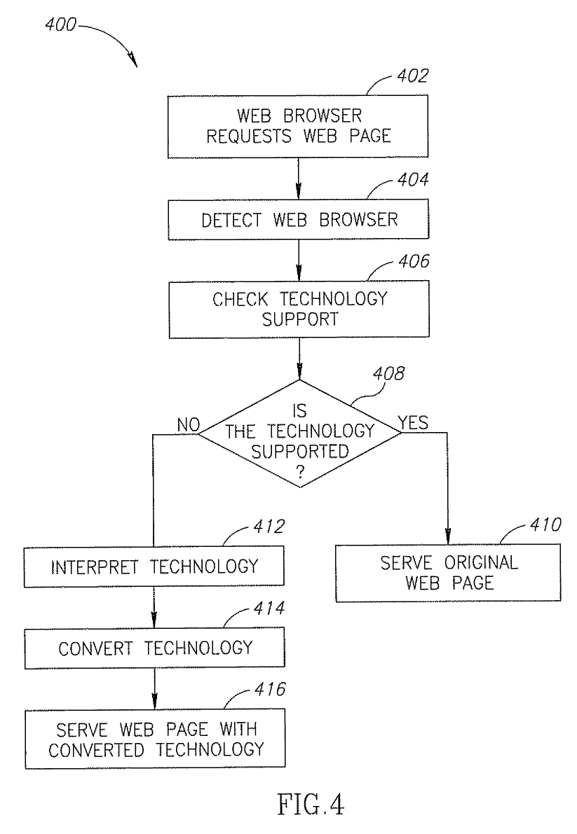

FIG. 4 is a flow chart schematically showing a process 400 of interpreting a web technology associated with a web page, according to an embodiment of the disclosure.

In a block 402, a web browser requests a web page. In a block 404, the web browser's type is detected. Optionally, the detection is performed using the web browser's User-Agent string. In a block 406, the web page is analyzed for one or more technologies, such as Javascript, associated with it. Then, a support of these one or, more technologies in the detected web browser is checked. Optionally, a web browser identifier is looked up in a database of known web browsers and their technology support. In a block 408, if the web browser is determined to support the one or more technologies associated with the web page, the website is served 410 to the web browser, without any changes made to its associated one or more technologies.

If it is determined that the web browser does not support the one or more technologies, these technologies are interpreted in a block 412 optionally using an interpreter. By way of example, if the web browser does not support Javascript, then Javascript elements, such as pop-up windows, are interpreted. A pop-up window is a web browser window whose opening is initiated by a web page, very often by the use of Javascript code. If a web browser does not support Javascript, the pop-up will most likely not appear in it. The interpretation of the web page optionally includes an analysis of the characteristics of the pop-up window, such as its size, contents, timing and/or the like.

In a block 414, after a non-supported technology is interpreted, it is converted to a format supported by the web browser, such as XHTML, optionally using a generator. In our pop-up example, a Javascript pop-up window is optionally converted to XHTML, so that it is displayed essentially like a regular web page—either within the original web page or in addition to it. For this purpose, the pop-up's characteristics, such as it its size, contents, timing and/or the like are optionally implemented using XHTML code, which is supported by the vast majority or virtually all web browsers.

In a block 416, the web page, alongside its associated converted technology, is served to the web browser, so that that a same or a similar functionality of the web page is reserved.

In an embodiment of the disclosure, if a client web browser requesting a web page is a mobile browser, and a size of an image associated with the web page exceeds a predefined size, the image size is reduced to fit the predefined size.

Since the screen size of mobile devices running mobile browsers is usually smaller than a PC screen size, many websites which are directed at PC web browsers do not appear correctly on mobile browsers. One of the related problems is that images associated with a web page are often larger than the viewable size of a mobile browser displaying these web pages. When a mobile browser displays such an image, it is often necessary to scroll sideways and/or downwards to view all parts of the image. An embodiment of the disclosure reduces the size of such images, so that they may be displayed on mobile browsers without the need to scroll.

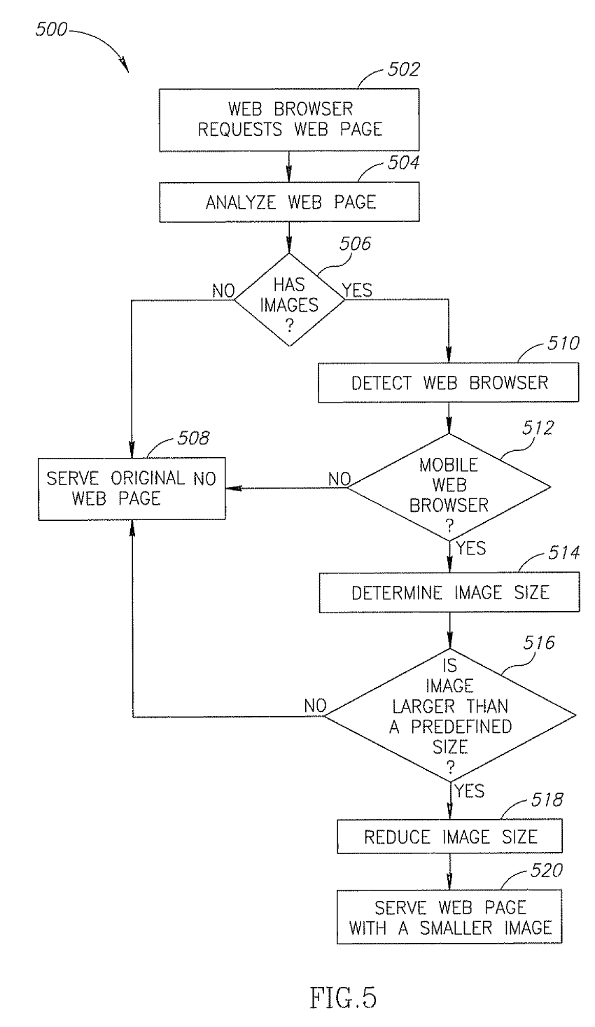

FIG. 5 is a flow chart schematically showing a process 500 of reducing a size of an image associated with a web page, according to an embodiment of the disclosure.

In a block 502, a web browser requests a web page. In a block 504, the web page is analyzed for associated images. An image may be associated with a web page using, for example, an “img” tag within the web page's HTML code. For example, a tag such as <img src=“example.jpg”/> often means that an image named example.jpg is associated with the web page. Additionally or alternatively, an image may be associated with a web page using other technologies, such as Javascript or Ajax. In a block 508, if no associated images are found, the original web page is served to the web browser without any alteration.

In a block 510, if one or more associated images were found, the web browser type is detected. Optionally, the detection is performed using the web browser's User-Agent string. In a block 512, it is determined whether the web browser is a mobile browser, by comparing the detected web browser type with a list of known mobile web browsers, such as a NetFront or an Opera mobile browser. In a block 508, if the web browser is not a mobile browser, the original web page is served to the web browser without any alteration.

In a block 514, if the web browser is a mobile browser, a size of the image associated with the web browser is determined. Digital image sizes are often square and are measured in pixels. For example, an image may have a height of 100 pixels and a width of 200 pixels. In a block 516, it is determined whether the image size exceeds a predefined size having a predefined height and/or a predefined width. Optionally, the predefined size corresponds to a viewable size of a mobile electronic device having the smallest viewable size amongst known mobile electronic devices, in order for the image to be displayed correctly in virtually all the known mobile electronic devices. It should be noted that the term “exceeds” may refer to either the height, the width or both.

In a block 508, if the image size does not exceed the predefined size, the original web page is served to the web browser without any alteration. In a block 518, if the image size does exceed the predefined size, the image size is reduced, optionally using a transcoder. Optionally, the image size is reduced so that its height-width ratio is reserved. For example, both the height and the width may be reduced by 50%. Optionally, the image size is reduced so that both its dimension (the height and the width) are smaller than the smallest dimension of the predefined size, in order for the image not to exceed either the height or the width of the mobile device's screen.

Block 518, in which the image size is reduced, is necessary if three conditions are met: a) the web page includes an associated image (block 506); b) the web browser is a mobile browser (block 512); c) the associated image is larger than a predefined size (block 516). Therefore, the order of checking the existence of these three conditions may be different than the optional, exemplary order shown in FIG. 5.

If the web page has more than one image associated with it that exceeds the predefined size, the action of block 518 may be repeated for every associated image.

In a block 520, the web page is served to the web browser alongside the one or more reduced-size associated images.

In an embodiment of the disclosure, if a client web browser requesting a web page is a mobile browser, and a menu of the web page is not located at the bottom part of the web page, the web page is served to the client web browser with the menu appearing at the bottom part of the web page.

Many web pages include contents that spread on an area taller than the computer screen used to view them. A user may scroll the web page downwards or upwards to view content that does not show up on the screen. Scrolling is often done by a mouse and sometimes by “up” and/or “down” buttons on a keyboard. Also, a “page up” and/or “page down” keyboard button(s) may be used for faster scrolling. Mobile electronic devices, however, usually lack a mouse, so scrolling is usually done by “up” and/or “down” buttons located on the device.

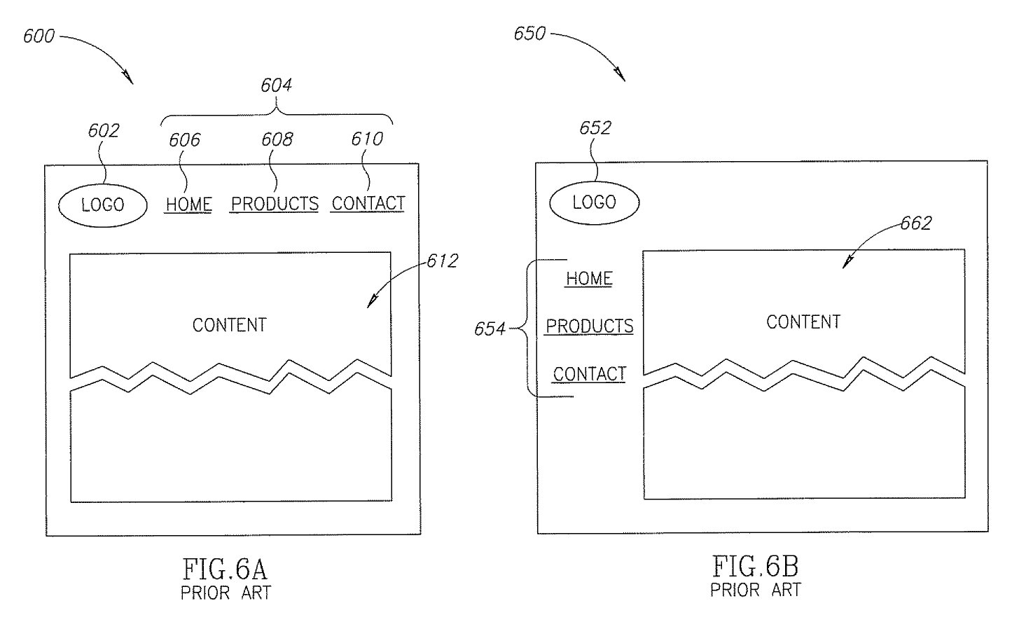

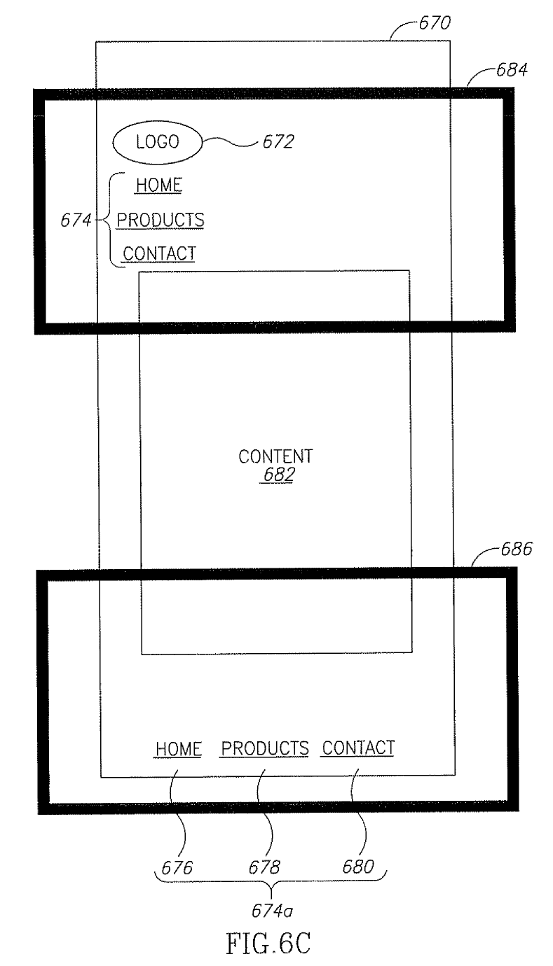

Web pages are often considered a Graphical User Interface (GUI), and usually include a menu (or “navigation”), a GUI element which includes links to other web pages, usually part of the same website. A website is often defined as an aggregate of web pages associated with each other and/or affiliated with one organization. Referring now to FIG. 6A, an exemplary web page 600 is shown. Web page 600 optionally includes a logo 602, such as a logo of an organization owning the web page. Next to logo 602 there is a menu 604, containing links to a “bionie” 606 page, a “Products” 608 page and a “Contact” 610 page—all are pages associated with a same website. Since menu 604 is located at the top area of web page 600, it may be referred to as a “top menu”. Web page 600 further includes a content 612, an area which may include text, images and/or other types of information.

FIG. 6B shows a web page 650 similar to web page 600 of FIG. 6A. Web page 650 includes a logo 652 and a content 662. However, a menu 654 of web page 650 is located at the left area of the web page, and may therefore be referred to as a “left menu”. If content 662 is taller than a viewable size of a web browser viewing the web page, then menu 654 may be said to practically exist in the top area of web page 650, since it is parallel to a relatively top area of content 662. In this aspect, both menu 604 of FIG. 6A and menu 654 of FIG. 6B may be regarded as menus residing at generally a top area of their corresponding web pages.

Similar to web pages 600 and 650, other web pages (not shown) may have menus located at different areas of the page.

When browsing a web page using a mobile browser, the user may scroll the page down, to a position where a menu is no longer visible. Then, if the user wishes to view the menu is order to click on one of the links it comprises, he needs to scroll all the way up until the menu is visible. Therefore, in accordance with an embodiment of the disclosure, a menu of a web page is relocated to a bottom area of the web page. Alternatively, a copy of the menu is placed at the bottom area of the web page.

FIG. 6C shows an exemplary web page 670 which is optionally similar to web page 650 of FIG. 6B, in the fact that their corresponding menus, menu 654 and a menu 674, are generally located at a left-top area of the page Web page 670 optionally includes a logo 672. Frames 684 and 686 represent two possible areas viewable by a screen of a mobile electronic device browsing web page 670. When a user of the mobile device first accesses web page 670 he is often shown a top area of the web page, such as the area within frame 684. When the user scrolls down, he may reach the bottom area of web page 670, shown within frame 686. In order to avoid the need to scroll all the way tip to the area of frame 684 to view menu 674 again, the menu is relocated or copied to the bottom area of web page 670, namely to bottom menu 674a. The user may use bottom menu 674, to access other web pages linked from it, such as a “Home” 676 page, a “Products” 678 page and/or a “Contact” 680 page.

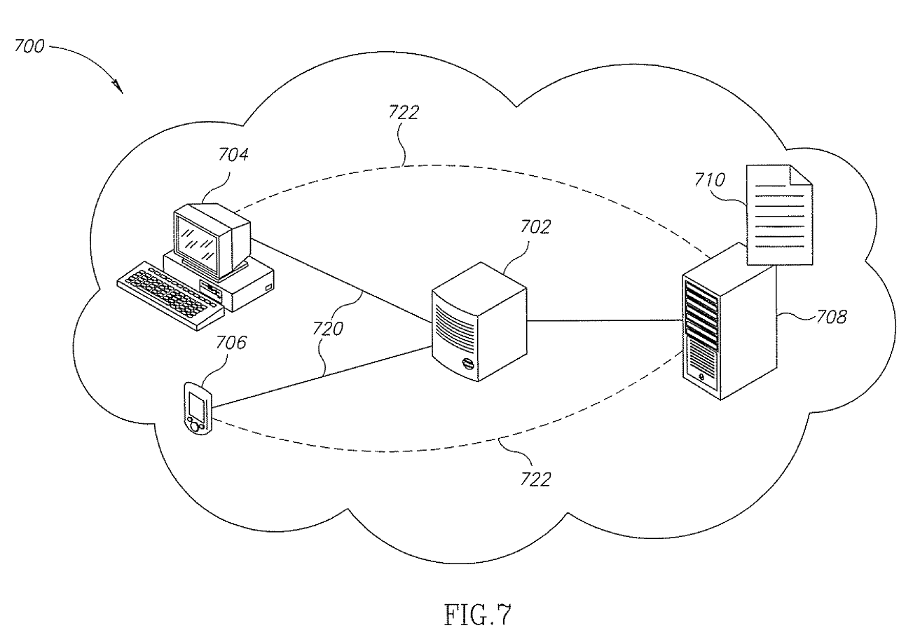

FIG. 7 shows exemplary implementations of various embodiments of the disclosure. A network 700, such as the Internet, may be used to access and interact with web pages. In an embodiment of the disclosure, a PC 704 or a mobile electronic device 706 requests a web page 710 located on a remote web server 708. The request is channeled from PC 704 or mobile device 706 through a communication link 720, to a proxy server 702. Communication links 720 may be wired or wireless. A proxy server is a server (a computer system or an application program) which services requests of clients by forwarding requests to other servers. A client connects to the proxy server, requesting some service, such as a file, a connection, a web page, or another resource, available from a different server. The proxy server provides the resource by connecting to the specified server and requesting the service on behalf of the client, A proxy server may optionally alter the client's request or the server's response.

Proxy server 702 is optionally adapted to perform process 100 of FIG. 1, process 200 of FIG. 2, process 300 of FIG. 3, process 400 of FIG. 4, process 500 of FIG. 5, and/or relocate or copy menu 674 of FIG. 6C. As such, proxy server 702 acts a middleman between a client, such as PC 704 or mobile device 706, and a resource, such as web page 710. Proxy server 702 optionally interprets, converts and/or adjusts data associated with a website, as laid out in the various disclosed embodiments.

In an embodiment, the capabilities of proxy server 702 described above are implemented in web server 708, so that the proxy server is not necessary. Web server 708 may include resident software adapted to perform the abovementioned tasks of proxy server 702. A client, such as PC 704 or mobile device 706, may connect to web server 708 essentially directly, through communication links 722, without being channeled through proxy server 702.

In the description and claims of the application, each of the words “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art. It is intended that the scope of the invention be limited only by the claims and that the claims be interpreted to include all such variations and combinations.

1. A system for interpreting data associated with a web page, comprising:
an interface module adapted to receive data associated with a web page;
an interpreter adapted to interpret an unsupported portion of said data; and
a generator for generating standard data from the interpreted unsupported portion.

2. The system according to claim 1, wherein the data associated with a web page is HyperText Markup Language (HTML) code.

3. The system according to claim 1, wherein the data associated with a web page is Cascading Style Sheets (CSS) code.

4. The system according to claim 1, wherein the data associated with a web page is Javascript code.

5. The system according to claim 1, wherein the data associated with a web page is a Uniform Resource Locator (URL) string.

6. The system according to claim 1, further comprising an image transcoder adapted to adjust an image size to fit a mobile device display.

7. The system according to claim 1, further comprising a graphical user interface (GUI) translator, adapted to place one or more GUI elements associated with said web page at a bottom area of said web page.

8. A method of interpreting data associated with a web page, comprising:
receiving data associated with a web page;
interpreting an unsupported portion of said data; and
generating standard data from the interpreted unsupported portion.

9. The method according to claim 8, wherein the data associated with a web page is HTML code.

10. The method according to claim 8, wherein the data associated with a web page is CSS code.

11. The method according to claim 8, wherein the data associated with a web page is Javascript code.

12. The method according to claim 8, wherein the data associated with a web page is a URL string.

13. A The method according to claim 8, further comprising adjusting an image size to fit a mobile device display.

14. The method according to claim 8, further comprising placing one or more GUI elements associated with said web page at a bottom area of said web page.

15. A proxy server adapted to relay data associated with a web page, comprising:
an interface module adapted to relay data associated with a web page between a client and a web server;
an interpreter adapted to interpret an unsupported portion of said data; and
a generator for generating standard data from the interpreted unsupported portion.

16. The proxy server according to claim 15, wherein the data associated with a web page is HTML code.

17. The proxy server according to claim 15, wherein the data associated with a web page is CSS code.

18. The proxy server according to claim 15, wherein the data associated with a web page is Javascript code.

19. The proxy server according to claim 15, wherein the data associated with a web page is a URL strings.

20. The proxy server, according to claim 15, further comprising an image transcoder adapted to adjust an image size to fit a mobile device display.

21. The proxy server according to claim 15, further comprising a GUI translator, adapted to place one or more GUI elements associated with said web page at a bottom area of said web page.
